(19) United States
(12) Patent Application Publication
(10) Pub. No.: US 2010/0154473 A1
(43) Pub. Date: Jun. 24, 2010

(54) Round brilliant cut diamond and its incision method

(75) Inventor: Xiben Xheng, Shenzhen City (CN)

Correspondence Address: DAVID AND RAYMOND PATENT FIRM, 108 N. YNEZ AVE., SUITE 128, MONTEREY PARK, CA, 91754, US

(73) Assignee: SHENZHEN ZHENCHENGMEI JEWELRY CO., LTD.

(21) Appl. No.: 12/660,474

(22) Filed: Feb. 26, 2010

Related U.S. Application Data
(63) Continuation-in-part of application No. 10/571,573, filed on Jul. 7, 2008.

(51) Int. Cl. A44C 17/00; B28D 5/00

(52) U.S. Cl. 63/32; 125/30.01

(57) ABSTRACT

The present invention discloses a round brilliant cut diamond. The diamond includes a crown, a girdle, and a pavilion, the cut crown includes one regular octagon table, eight first facets, eight second facets, and sixteen third facets, wherein the cut pavilion has sixteen quadrangular fourth facets, sixteen quadrangular fifth facets, and sixteen sub-triangular sixth facets. The sixteen fourth facets meet at a point, which forms an apex, and each fourth facet, fifth facet and sixth facet meet a point. A depth of the fourth facets is smaller than 21.6% of the total girdle diameter D. The present invention also discloses methods for preparing above mentioned round brilliant-cut diamond.

### CROSS REFERENCE OF RELATED APPLICATION

This is a Continuation-In-Part application of a non-provisional application having an application Ser. No. 10/571,573 and a filing date of Mar. 9, 2006.

### BACKGROUND OF THE PRESENT INVENTION

1. Field of Invention

The present invention relates to diamond cutting method, and more particularly, relates to a kind of round brilliant cut diamond as well as the method for preparing thereof, wherein the brilliance of the diamond can be significantly enhanced by the tip cut arrangement for better light reflection and the manufacturing process of the diamond can be significantly reduced by the facet arrangement, so as to dramatically increase the commercial value thereof.

2. Description of Related Arts

Round brilliant cut diamond, also known as standard brilliant cut diamond, is the hottest style available in current market. Ordinarily, a standard round brilliant-cut diamond comprises a crown portion, a girdle portion and a pavilion portion for defining total 57 facets thereon, wherein the crown portion has a table facet and three set of crown facets with a total of 33 facets, the pavilion portion has two set of pavilion facets with a total of 24 facets. Actually, the girdle portion is embodied as a cylinder shape. The reason why such type of diamond is referred as round brilliant diamond could be attributed to such cylinder shape girdle portion. That is to say, the cross section of the girdle of the diamond is round shape. As shown in FIG. 1, FIG. 2 and FIG. 3, a round brilliant-cut diamond comprises a crown portion 91, a girdle portion 92 and a pavilion portion 93 for defining 57 facets, wherein the crown portion 91 has a octagonal table facet, eight first facets 912, eight second facets 913, sixteen third facets 914, eight fourth facets provided onto the pavilion portion 92, and sixteen fifth facets 932.

The brilliancy, dispersion and flickering of the diamond are varied by its cut. That is to say, the quality of the diamond is not only determined by its intrinsic property, such as the size of the raw stone, the light reflection rate and so on, but also depended on the cutting craftwork. In other words, the brilliancy and dispersion of the diamond is achieved by cutting the diamond into a plurality of evenly distributed facets. The size and shape of such facets will be the key factor attributed to a fine diamond. A well defined cut will increase the visual-perceptible reflection of light ray thus improving the brilliancy whenever such diamond is observed by a user. It is therefore seen stricter orders and procedures have been introduced within the art instructing people to cut the diamond.

However, the conventional 57 facets cutting method is not desirable for preparing a relatively larger raw stone. The brilliance and flickering effect would be look inanimate and uncharacteristic. On the other hand, the arrangement and orienting angle setting of the facets are also important to achieve desirable physical reflection rays.

In addition, people are still seeking a better diamond cutting structure and method to increase the number of refractive index, so that the brilliance as long as the dispersive power of the diamond are able to be increased for a better light reflecting result of the diamond, so as to enhance the quality and the aesthetic feelings thereof to increase the marketing value of the processed diamond.

Accordingly, the differences of the facet arrangements and combinations, even a slightly difference thereof, can significantly result to the brilliance and the dispersion of the commercial diamond. The steep pavilion angle can be complemented by a shallower crown angle, and vice versa. Therefore, making an effort to find out the slightly different ratio or arrangements for a better or nearly perfect brilliant commercial diamond is the key point to increase the commercial value thereof.

### SUMMARY OF THE PRESENT INVENTION

An object of the present invention is to provide a diamond cutting structure, wherein an interfacial angle and arrangement of the facets of the diamond are arranged to maximize the brilliancy thereof while minimizing the number of the facet to simplify the diamond cutting process, so as to minimize the weight loss of the diamond after the cutting of the diamond.

Another object of the present invention is to provide a diamond cutting structure, wherein at least 3 sets of facets are provided at the pavilion portion of the diamond to increase the reflecting surface to increase the brilliancy thereof.

Another object of the present invention is to provide a diamond cutting structure, wherein a fourth set of the facets are provided at bottom portion of the pavilion portion, wherein a depth of the fourth set facets are smaller than 21.6% of total girdle diameter or smaller than 50% of total pavilion depth, so that the light projected on the internal surface of the fourth facets are able to be concentratively reflected from the top crown portion of the diamond.

Another object of the present invention is to provide a diamond cutting method for not only increasing the quantity of facets, but also perfecting the relative angles, size and arrangement of such facets, therefore, the diamond prepared in present invention will be observed with improved brilliancy and ray dispersion.

Another object of the present invention is to provide a diamond cutting method for increasing facets on the pavilion portion of the diamond, namely 3-5 sets of facets on the pavilion portion, wherein the newly added facets are harmonized with crown portion facets so as to reinforce the internal flickering, ray dispersion and overall brilliance of the diamond.

Accordingly, to achieve above object, the present invention provides a cutting method for cutting at least 3-5 set of pavilion facets for substantially exhibiting the flickering, dispersion and brilliancy of the diamond.

These and other objectives, features, and advantages of the present invention will become apparent from the following detailed description, the accompanying drawings, and the appended claims.

### BRIEF DESCRIPTION OF THE DRAWINGS

FIG. 1 is a top view of a standard 57 facets round brilliant-cut diamond.

FIG. 2 is a side view of a standard 57 facets round brilliant-cut diamond.

FIG. 3 is a bottom view of a standard 57 facets round brilliant-cut diamond.

FIG. 4 is a side view of above round brilliant-cut diamond according to a first preferred embodiment of the present invention.

FIG. 5 is a bottom view of above round brilliant-cut diamond according to the second embodiment of the present invention.

FIG. 6 is another side view of a standard 57 facets round brilliant-cut diamond, illustrating the reflective and refractive light thereof.

FIG. 7 is a side view of a round brilliant-cut diamond according to a second preferred embodiment of the present invention, illustrating the reflective and refractive light thereof.

FIG. 8 is another side view of the round brilliant-cut diamond according to the above second preferred embodiment of the present invention, illustrating the dimensions of diamond.

FIG. 9 is a top view of the round brilliant-cut diamond according to the above second preferred embodiment of the present invention.

FIG. 10 is a bottom view of the round brilliant-cut diamond according to the above second preferred embodiment of the present invention.

FIG. 11 is a partially view of the round brilliant-cut diamond according to the above fifth preferred embodiment of the present invention, illustrating the obtuse bottom peak point of the diamond.

### DETAILED DESCRIPTION OF THE PREFERRED EMBODIMENT

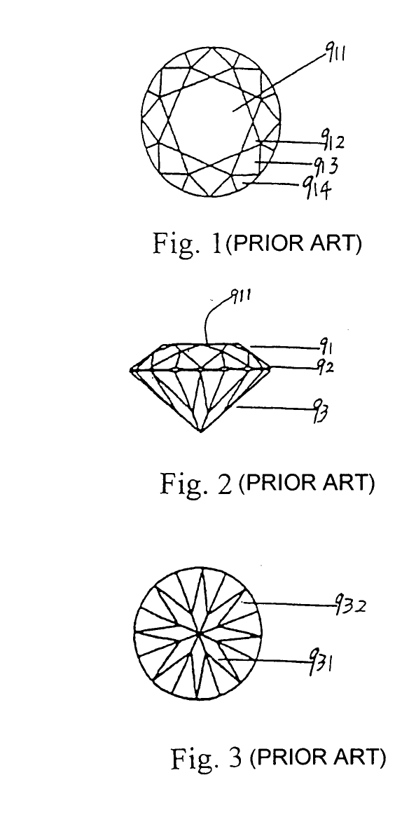

As shown in FIG. 1, FIG. 2, and FIG. 3, a conventional standard round brilliant-cut diamond is illustrated, wherein the diamond comprises a crown portion 91 having an octagonal table facet 911, eight first facets 912, eight second facets 913, and sixteen third facets 914, and a pavilion portion 92 having eight fourth facets 931 and sixteen fifth facets 932.

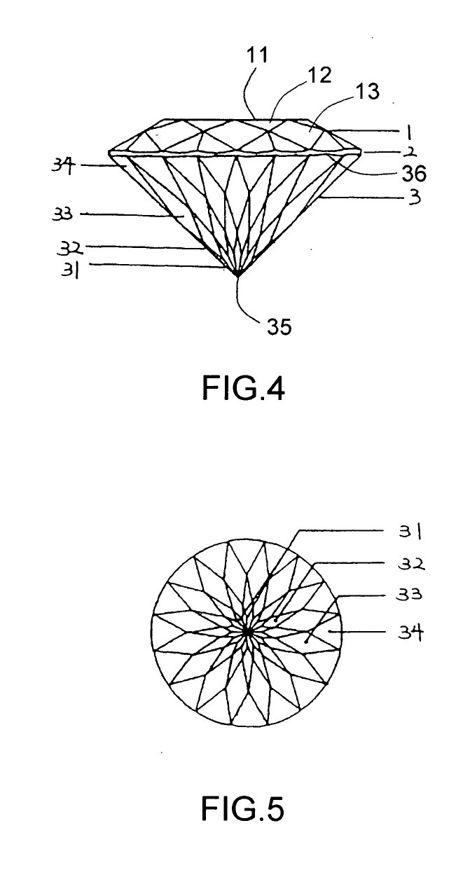

Referring to FIG. 4 and FIG. 5, the round brilliant-cut diamond prepared according to a preferred embodiment of the present invention is illustrated. The pavilion 3 comprise sixteen quadrangle shaped fourth facets 31, sixteen quadrangle shaped fifth facets 32, sixteen quadrangle sixth facets 33, and sixteen sub-sector shaped seventh facets 34, wherein the fourth facets 31 are merged into a bottom peak, each of the correspondingly grouped fourth facet 31, fifth facet 32 and sixth facet 33 is also merged into a joint point. Preferably, the fourth facet 31 is prepared with a diamond shape. It is noted that a pair of short side edges of the fifth facets 32 are embodied as side edges of neighboring fourth facets 31. Meanwhile, the remaining two long side edges of the fifth facets 32 are sized twice as the length of the side edges of the fourth facets 31. And the pavilion angle of the pavilion portion 3 is defined within a range between 40.8° and 41.5°. Furthermore, the length ratio between the table facet width and the diameter of the girdle portion is around 0.56.

Accordingly, the present invention further provides a corresponding method for cutting the diamond of above second preferred embodiment. First of all, the crown portion 1 is cut to define a table facet 11, a plurality of first facets 12, a plurality of second facets 13, and a plurality of third facets 14. Afterwards, the upper edge 36 of the pavilion portion 3 is cut to define sixteen fourth facets 31. After then, each of the included angles between neighboring fourth facets 31 is cut to define sixteen fifth facets 32; and each of the included angles between neighboring fifth facets 31 is cut to define sixteen sixth facets 33. Finally, each of the included angles between neighboring sixth facets 33 at a position adjacent to the girdle portion 2 is cut to define sixteen sub-diamond shaped seventh facets 34.

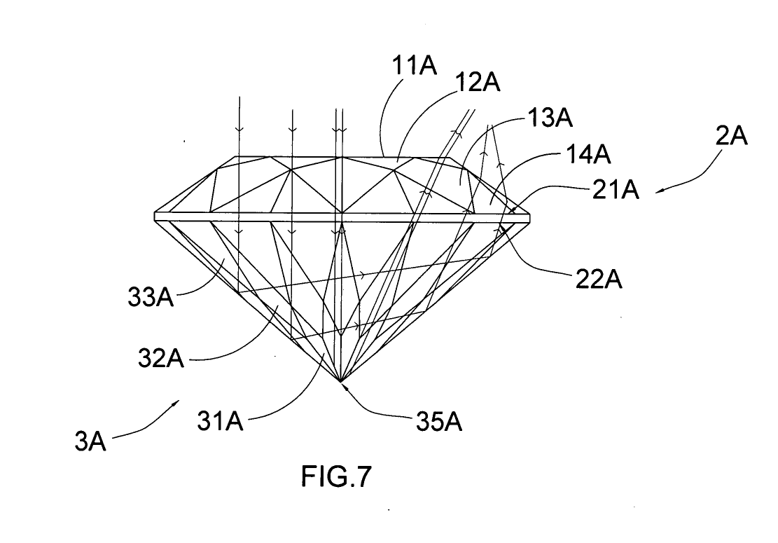

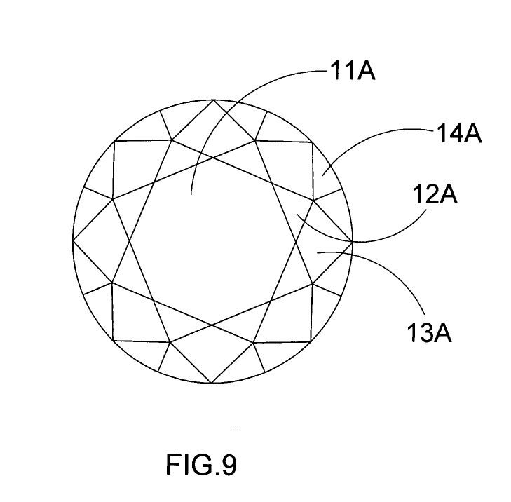

Referring to FIGS. 7 to 11 of the drawings, a round brilliant-cut diamond according to a second preferred embodiment of the present invention is illustrated, wherein the round brilliant-cut diamond comprises a crown portion 1A, a girdle portion 2A, and a pavilion portion 3A. The crown portion 1A has a table facet 11A and three sets of facets having similar structure of the above mentioned facets at the crown portion 1A, wherein the three sets of facets at the crown portion 1A are eight first facets 12A, eight second facets 13A, and sixteen third facets 14A, as shown in FIG. 9.

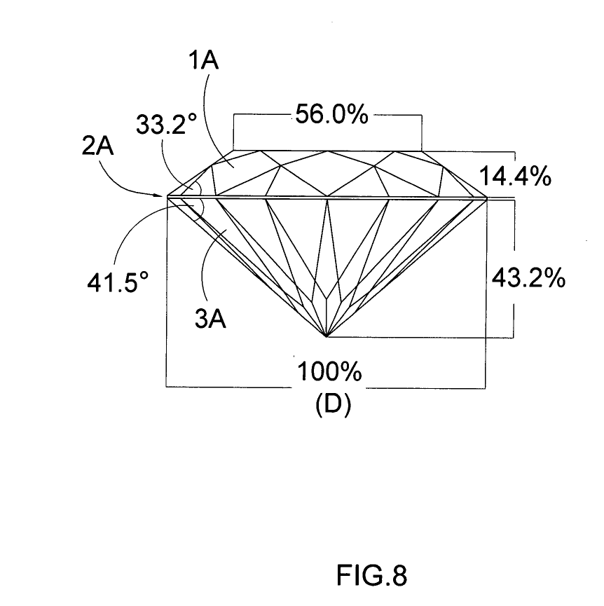

According to the second preferred embodiment of the present invention, the table facet 11A having an octagonal shape preferably has a width proportionally sized with respect to the diameter of the girdle portion 2A, wherein the width of the table facet 11A is preferably 56% of a total girdle diameter D. A height of the crown portion 1A, which is a distance between the girdle portion 2A and the surface of the table facet 11A, is preferably 14.4% of the total diameter D of the girdle portion 2A, while a height of the pavilion portion 3A, which is a vertical distance from a bottom peak point 35A of the pavilion portion 3A to the girdle portion 2A, is preferably 43.2% of the total girdle diameter D, as best shown in FIG. 8.

The pavilion portion 3A has three facet arrangements extended from the girdle portion 2A to the bottom peak point 35A to incorporate with the crown portion 1A for light refraction. The three facet arrangements of the pavilion portion 3A are a tip cut arrangement, body cut arrangement, and top cut arrangement. Accordingly, the pavilion portion 3A has only forty-eight facets.

Accordingly, the tip cut arrangement comprises sixteen quadrangle shaped fourth facets 31A, wherein the sixteen fourth facets 31A are merged into the bottom peak point 35A. The body cut arrangement comprises sixteen quadrangle shaped fifth facets 32A.

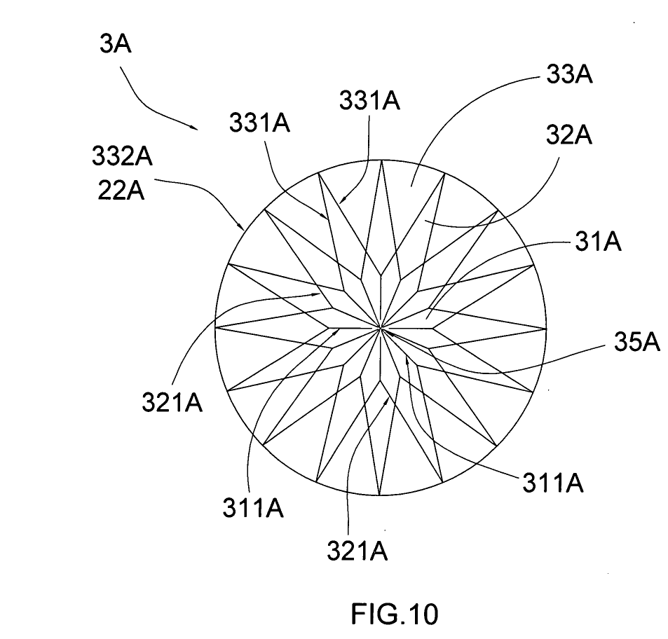

The top cut arrangement comprises sixteen sub-triangle shaped sixth facets 33A. As shown in FIG. 10, each of the sixth facets 33A is preferably an isosceles triangle shaped having at least two equal length sides of sixth side edges 331A and a third girdle side edge 332A of the sixth facet 33A formed part of a peripheral edge of the girdle portion 2A.

In other words, the girdle portion 2A has an upper peripheral edge 21A formed via one side edge of each of said third facets 33A and a lower peripheral edge 22A to form a substantially circular shaped girdle portion. Accordingly, the upper peripheral edge 21A of the girdle portion 2A is parallel to the lower peripheral edge 22A, such that the width of the girdle portion 2A is even. The circular shaped girdle portion has the total girdle diameter D, wherein the crown portion 1A is provided at a position above the girdle portion 2A, while the pavilion portion 3A is provided at a position below the girdle portion 2A to sandwich the girdle portion 2A therebetween.

As best shown in FIG. 10, the quadrangle shaped fourth and fifth facets 31A, 32A are preferably kite shaped, which has two equal lengthened lower side edges, and two equal lengthened upper side edges. Accordingly, each of the fourth facets 31A has two fourth lower side edges 311A extended to form the bottom peak point 35A of the pavilion portion 3A, wherein two neighboring fourth facets 31 share one fourth lower side edge 311A as a common edge such that the sixteen quadrangle shaped fourth facet 31A sharing sixteen fourth lower side edges 311A to form the tip cut arrangement. Each of the fourth facets 31A further has two fourth upper side edges 321A extended from the fourth lower side edges 311A respectively, wherein the fourth upper side edges 321A of each of the fourth facets 31A form two fifth lower side edges of two neighboring fifth facets 32A as two common edges sharing with the fifth facets 32A. Accordingly, the length of the fourth upper side edge 321A of each of the fourth facets 31A is shorter than the length of the fourth lower side edge 311A thereof. Accordingly, the tip portion of the pavilion portion 3A can be obtusely formed by configuring the fourth lower side edges 311A of the fourth facets 31A shorter than the fourth upper side edges 321A thereof for enhancing the light being effectively and concentratively reflected back to the crown portion 1A.

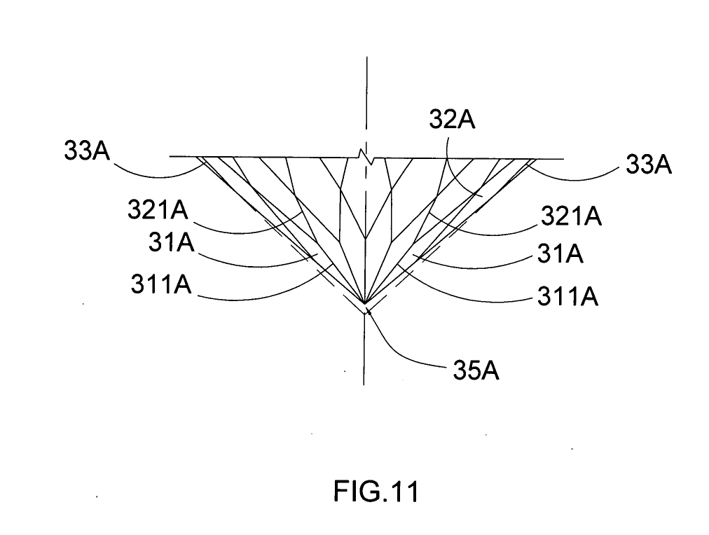

Accordingly, a tip angle of the pavilion portion 3A at the bottom peak point 35A with respect to the tip cut arrangement, i.e. the angle of the fourth facets 31A, is larger than a projected tip angle of the pavilion portion 3A at the bottom peak point 35A with respect to the body cut arrangement, i.e. the angle of the sixth facets 33A, so as to form the obtuse bottom peak point 35A of the diamond, as shown in FIG. 11.

Each of the fifth facets 32A has two fifth lower side edges 321A sharing with the fourth upper side edges of the neighboring fourth facets 31A, and two fifth upper side edges 331A extended from the fifth side edges 321A respectively to form the body cut arrangement. The fifth upper side edges 331A of each of the fifth facets 32A form two sixth lower side edges of two neighboring sixth facets 33A as two common edges sharing with the sixth facets 33A. Accordingly, the length of the fifth lower side edge 321A of each of the fifth facets 32A is shorter than the length of the fifth upper side edge 331A thereof. Therefore, the body cut arrangement of the pavilion portion 3A can be gradually reduced its circumferential size towards the bottom peak point 35A so as to enable light being effectively and concentratively reflected back to the crown portion 1A.

Accordingly, the two upper fifth side edges 331A of each of the fifth facets 32A are two common edges of two sixth lower side edges of two neighboring sixth facets 33A, wherein the upper fifth side edges 331A are equal in length.

In other words, the fourth facets 31A are merged into the bottom peak point 35A and formed edge-to-edge with two neighboring fourth facets 31A via two four lower side edges 311A thereof, wherein each of the fifth facets 32A is upwardly extended from two fifth lower side edges 321A at a position between two neighboring fourth facets 31A. Two fifth upper side edges 331A of the fifth facets 32A are formed two equal length sides of the triangular shaped sixth facet 33A. A plurality of girdle side edges 332A of another side edge of the triangular sixth facet 33A are formed the lower peripheral edge 22A of the girdle portion 2A.

It is worth mentioning that the fourth lower side edges 311A are longer than the fifth lower side edges 321A, so that each of the fourth facets 31A is formed an upright kite shape having two longer sides at the lower side edges thereof, while each of the fifth facets 32A is formed an inversed kite shape, which has two shorter sides at the lower side edges of each of the fifth facets 32A. Therefore, the above arrangement of the facets of the diamond is able to effectively enhance the dispersion and brilliancy diamond by reflecting and refracting the refractive light back from the crown portion 1A to a viewer, as shown in FIG. 7 of the drawings.

More specifically, a depth of the fourth facets 31A is at least smaller than 21.6% of the total girdle diameter D, wherein the depth of the fourth facets 31A is a vertical distance from the bottom peak point 35A to a vertex of the kite shaped fourth facet 31A where the two upper fifth side edges 321A of the fourth facet 31A meet or intersect. In other words, the length of the fourth facets 31A is smaller than 50% of the length of the pavilion portion 3A, preferably not larger than ⅓ of the pavilion portion 3A, in such a manner that more the refractive lights of the diamond reflected and refracted back to the viewer are able to be concentratively reflected from the top crown portion 1A of the diamond within the range of the total girdle diameter D, as best shown in FIG. 7.

Therefore, the fifth lower side edges 321A are preferably longer than the fourth lower side edges 311A to form the kite shaped fourth facets 31A and the inversed kite shaped fifth facets 32A. Thus, a length ratio between the sixth upper side edge 331A and the fifth lower side edge 321A is preferably around 2.5. A length ratio between the fourth lower side edge 311A and the fifth lower side edge 321A is preferably around 1.5.

As shown in FIG. 7, when the light is perpendicularly projected to the table facet 11A of the crown portion 1A at the critical point between the sixth facet 33A and the fifth facet 32A, i.e. along the upper fifth side edge or the lower sixth side edge 331A, the light will be refracted back to the crown portion 1A by another sixth facet 33A. Therefore, the length of each of the sixth facets 33A must be long enough for maximizing the light being concentratively refracted back to the crown portion 1A so as to enhance the brilliancy of the diamond. Accordingly, the length of each of the sixth facets 33A must be longer than 50% of the length of the pavilion portion 3A.

When the light is perpendicularly projected to the table facet 11A of the crown portion 1A at the critical point between the fifth facet 32A and the fourth facet 31A, i.e. along the upper fourth side edge or the lower fifth side edge 321A, the light will be concentratively refracted back to the crown portion 1A by another fifth facet 33A. Therefore, the length of each of the fifth facets 32A must be long enough for maximizing the light being refracted back to the crown portion 1A so as to enhance the brilliancy of the diamond.

When the light is perpendicularly projected to the table facet 11A of the crown portion 1A close to the bottom peak point 35A, the light will be refracted back to the table facet 11A of the crown portion 1A. It is worth mentioning that since the tip portion of the pavilion portion 3A is obtusely formed by configuring the fourth lower side edges 311A of the fourth facets 31A shorter than the fourth upper side edges 321A thereof, the light will be more focused at the tip portion to be refracted back to the crown portion 1A, so as to minimize the dark refraction area of the diamond. In addition, the obtuse bottom peak point 35A can prevent the tip of the diamond from chipping or breaking.

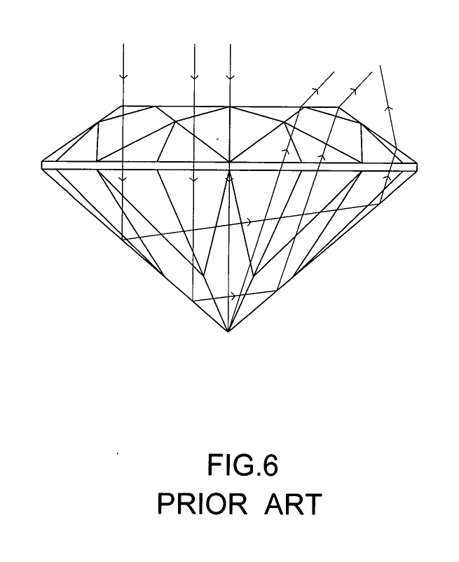

Compare the diamond of the present invention best shown in FIG. 7 to a conventional diamond shown in FIG. 6, the lights refracted from the crown portion 1A of the diamond have relatively higher light intensity due to the more concentrated light reflected and refracted back to the top surface of the crown portion 1A. Furthermore, the refraction angle of the refractive light refracted from the top table facet 11A shown in FIG. 7 is smaller than the refraction angle of the conventional diamond shown in FIG. 6, so that the refraction of the light is able to be more focused within the range of the total girdle diameter D, so as to enhance the brilliancy of the diamond and the light dispersion of the diamond.

As mentioned above, a crown angle, which is an angle between the third facet 14A and a surface of the girdle portion 2A, is preferably 33.2°. The pavilion angle, which is an angle between the sixth facet 33A and the surface of the girdle portion 2A, is preferably 41.5°, in such a manner that the facets arrangement at the crown portion 1A as long as the crown angle thereof is able to incorporating with the pavilion portion 3A, which has the facets arrangement and the pavilion angle as described above in order to maximize the brilliancy and dispersive power of the diamond.

Accordingly, the present invention also provides a method for cutting the diamond of the above preferred embodiment, wherein the method comprises the following steps.

(a) Cut a precious stone of original crystal of diamond to form the table facet 11A of the crown portion 1A of the diamond.

(b) Cut the precious stone to form the eight first facets 12A, sixteen second facets 13A, and sixteen third facets 14A to form the crown portion 1A, so as to form the upper peripheral edge 21A of the girdle portion 2A.

(c) Cut the precious stone to form the kite shaped fourth facets 31A at a bottom of the precious stone to form the pavilion portion 3A of the diamond, wherein two neighboring fourth facets 31A are sharing one of the fourth side edges therebetween to form the continuous sixteen fourth facets 31A at the bottom portion of the pavilion portion 3A, so as to form the bottom peak point 35A thereat.

(d) Cut the pavilion portion 3A to form the kite shaped fifth facets 32A, wherein each of the fifth facets 32A is formed between two neighboring fourth facets 31A at a position that the two lower side edges of fifth facet 32A are sharing with the two upper side edges of the two neighboring fourth facets 31A respectively to form the shared fifth side edges 321A therebetween.

(e) Cut the pavilion portion 3A to form the isosceles triangle shaped sixth facets 33A, wherein each of the sixth facets 33A is formed between two neighboring fifth facets 32A at a position that the two lower side edges of two equal length sides of the sixth facet 33A are sharing with the two upper side edges of the two neighboring fifth facets 32A respectively to form the shared sixth side edges 331A therebetween.

Therefore, after cutting the sixth facets 33A, the lower peripheral edge 22A of the girdle portion 2A is also formed by each of the girdle edges of each of the triangular shaped sixth facets 33A. It is worth to mention that the upper peripheral edge 21A and lower peripheral edge 22A of the girdle portion 2A are preferably parallel to each other.

Accordingly, the table facet 11A having an octagonal shape preferably has a width proportionally sized with respect to the diameter of the girdle portion 2A, wherein the width of the table facet 11A is preferably 56% of a total girdle diameter D. A high of the crown portion 1A, which is a distance between the girdle portion 2A and the surface of the table facet 11A, is preferably 14.4% of the total diameter D of the girdle portion 2A, while a depth of the pavilion portion 3A, which is a vertical distance from a bottom peak point 35A of the pavilion portion 3A to the girdle portion 2A, is preferably 43.2% of the total girdle diameter D, as best shown in FIG. 8.

A length of the fourth facets 31A is preferably smaller than 21.6% of the total girdle diameter D, wherein the length of the fourth facets 31A is a vertical distance from the bottom peak point 35A to a vertex of the kite shaped fourth facet 31A where the two upper fifth side edges 321A of the fourth facet 31A meet or intersect. In other words, the length of the fourth facets 31A is preferably smaller than 50% of the depth of the pavilion length, in such a manner that more the refractive lights of the diamond reflected and refracted back to the viewer are able to be concentratively reflected from the top crown portion 1A of the diamond within the range of the total girdle diameter D, as best shown in FIG. 7.

As mentioned above, the crown angle is preferably 33.2°. The pavilion angle is preferably 41.5°, in such a manner that the facets arrangement at the crown portion 1A as long as the crown angle thereof is able to incorporating with the pavilion portion 3A, which has the facets arrangement and the pavilion angle as described above, in order to maximize the brilliancy and dispersive power of the diamond.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A round brilliant-cut diamond, comprising:
a crown portion;
a girdle portion; and
a pavilion portion having a tip cut arrangement, a body cut arrangement, and a top cut arrangement, wherein said tip cut arrangement has a length not larger than ⅓ of a length of said pavilion portion and comprises sixteen quadrangle shaped fourth facets merging into a bottom peak point of said pavilion portion for enhancing light being concentratively reflected at said fourth facets back to said crown portion so as to maximize the brilliancy of said diamond.

2. The round brilliant-cut diamond, as recited in claim 1, wherein each of said fourth facets has two fourth lower side edges extended to form said bottom peak point of said pavilion portion and two fourth upper side edges extended from said fourth lower side edges to form a quadrangle shape, wherein a length of said fourth upper side edge of each of said fourth facets is shorter than a length of said fourth lower side edge thereof, such that said fourth facets are adapted for effectively enhancing the dispersion and brilliancy diamond by reflecting and refracting the light back from said crown portion.

3. The brilliant-cut diamond, as recited in claim 2, wherein said body cut arrangement comprises sixteen quadrangle shaped fifth facets extended from said tip cut arrangement, wherein each of said fifth facets has two lower fifth side edges sharing with said fourth upper side edges of two of said neighboring fourth facets, and two upper fifth side edges extended from said lower fifth side edges respectively to form a quadrangle shape, wherein a length of said fifth lower side edge of each of said fifth facets is shorter than a length of said fifth upper side edge thereof.

4. The brilliant-cut diamond, as recited in claim 3, wherein said top cut arrangement comprises sixteen sub-triangle shaped sixth facets, wherein each of said sixth facets has two sixth lower side edges sharing with said fifth lower side edges of two of said neighboring fifth facets, wherein said sixth lower side edges of each of said sixth facets are equal in length.

5. The brilliant-cut diamond, as recited in claim 4, wherein a length ratio between said sixth upper side edge and said fifth lower side edge is around 2.5, and a length ratio between said fourth lower side edge and said fifth lower side edge is around 1.5.

6. The brilliant-cut diamond, as recited in claim 1, wherein a tip angle of said pavilion portion at said bottom peak point with respect to said tip cut arrangement is larger than a projected tip angle of said pavilion portion at said bottom peak point with respect to said body cut arrangement, so as to form said obtuse bottom peak point of said diamond.

7. The brilliant-cut diamond, as recited in claim 5, wherein a tip angle of said pavilion portion at said bottom peak point with respect to said tip cut arrangement is larger than a projected tip angle of said pavilion portion at said bottom peak point with respect to said body cut arrangement, so as to form said obtuse bottom peak point of said diamond.

8. The brilliant-cut diamond, as recited in claim 1, wherein said girdle portion has an upper peripheral edge formed at one side edge of said crown portion and a lower peripheral edge formed at one side edge of said pavilion portion so as to form a substantially circular shaped girdle portion, wherein said upper peripheral edge of said girdle portion is parallel to said lower peripheral edge thereof.

9. The brilliant-cut diamond, as recited in claim 7, wherein said girdle portion has an upper peripheral edge formed at one side edge of said crown portion and a lower peripheral edge formed at one side edge of said pavilion portion so as to form a substantially circular shaped girdle portion, wherein said upper peripheral edge of said girdle portion is parallel to said lower peripheral edge thereof.

10. The brilliant-cut diamond, as recited in claim 1, wherein said crown portion, which incorporates with said tip cut arrangement for light refraction, has a table facet having an octagonal shape, eight first facets, eight second facets, and sixteen third facets, wherein a width of said table facet is 56% of a total girdle diameter of said girdle portion, wherein a height of said crown portion, which is a distance between said girdle portion and a surface of said table facet, is 14.4% of the total girdle diameter of said girdle portion, wherein a height of the pavilion portion, which is a vertical distance from said bottom peak point of said pavilion portion to said girdle portion, is 43.2% of said total girdle diameter of said girdle portion.

11. The brilliant-cut diamond, as recited in claim 9, wherein said crown portion, which incorporates with said tip cut arrangement for light refraction, has a table facet having an octagonal shape, eight first facets, eight second facets, and sixteen third facets, wherein a width of said table facet is 56% of a total girdle diameter of said girdle portion, wherein a height of said crown portion, which is a distance between said girdle portion and a surface of said table facet, is 14.4% of the total girdle diameter of said girdle portion, wherein a height of the pavilion portion, which is a vertical distance from said bottom peak point of said pavilion portion to said girdle portion, is 43.2% of said total girdle diameter of said girdle portion.

12. A method of cutting a brilliant-cut diamond, comprising the steps of:
(a) cutting a crown portion to form a table facet having an octagonal shape, eight first facets, eight second facets, and sixteen third facets; and
(b) cutting a pavilion portion, which defines a girdle portion between said crown portion and said pavilion portion, by the steps of:
(b.1) forming a tip cut arrangement;
(b.2) forming a body cut arrangement; and
(b.3) forming a tip cut arrangement, wherein said tip cut arrangement has a length not larger than ⅓ of a length of said pavilion portion and comprises sixteen quadrangle shaped fourth facets merging into a bottom peak point of said pavilion portion for enhancing light being concentratively reflected at said fourth facets back to said crown portion so as to maximize the brilliancy of said diamond.

13. The method as recited in claim 12 wherein, in the step (b.3), each of said fourth facets has two fourth lower side edges extended to form said bottom peak point of said pavilion portion and two fourth upper side edges extended from said fourth lower side edges to form a quadrangle shape, wherein a length of said fourth upper side edge of each of said fourth facets is shorter than a length of said fourth lower side edge thereof, such that said fourth facets are adapted for effectively enhancing the dispersion and brilliancy diamond by reflecting and refracting the light back from said crown portion.

14. The method as recited in claim 13 wherein, in the step (b.2), said body cut arrangement comprises sixteen quadrangle shaped fifth facets extended from said tip cut arrangement, wherein each of said fifth facets has two lower fifth side edges sharing with said fourth upper side edges of two of said neighboring fourth facets, and two upper fifth side edges extended from said lower fifth side edges respectively to form a quadrangle shape, wherein a length of said fifth lower side edge of each of said fifth facets is shorter than a length of said fifth upper side edge thereof.

15. The method as recited in claim 14 wherein, in the step (b.1), said top cut arrangement comprises sixteen sub-triangle shaped sixth facets, wherein each of said sixth facets has two sixth lower side edges sharing with said fifth lower side edges of two of said neighboring fifth facets, wherein said sixth lower side edges of each of said sixth facets are equal in length.

16. The method, as recited in claim 15, wherein a length ratio between said sixth upper side edge and said fifth lower side edge is around 2.5, and a length ratio between said fourth lower side edge and said fifth lower side edge is around 1.5.

17. The method as recited in claim 16 wherein, in the step (b), a tip angle of said pavilion portion at said bottom peak point with respect to said tip cut arrangement is larger than a projected tip angle of said pavilion portion at said bottom peak point with respect to said body cut arrangement, so as to form said obtuse bottom peak point of said diamond.

18. The method as recited in claim 17 wherein, in the step (b), said girdle portion has an upper peripheral edge formed at one side edge of said crown portion and a lower peripheral edge formed at one side edge of said pavilion portion so as to form a substantially circular shaped girdle portion, wherein said upper peripheral edge of said girdle portion is parallel to said lower peripheral edge thereof.

19. The method, as recited in claim 18, wherein a width of said table facet is 56% of a total girdle diameter of said girdle portion, wherein a height of said crown portion, which is a distance between said girdle portion and a surface of said table facet, is 14.4% of the total girdle diameter of said girdle portion, wherein a height of the pavilion portion 3A, which is a vertical distance from said bottom peak point of said pavilion portion to said girdle portion, is 43.2% of said total girdle diameter of said girdle portion.

20. A round brilliant-cut diamond, comprising:
a crown portion having an octagonal shaped table facet, eight first facets, eight second facets, and sixteen third facets cut thereon;
a girdle portion; and
a pavilion portion having a tip cut arrangement, a body cut arrangement, and a top cut arrangement;
wherein a crown angle is about 33.2° and a pavilion angle is about 41.5°, wherein a width of said table facet is 56% of a total girdle diameter of said girdle portion, wherein a height of said crown portion, which is a distance between said girdle portion and a surface of said table facet, is 14.4% of the total girdle diameter of said girdle portion, wherein a height of the pavilion portion, which is a vertical distance from a bottom peak point of said pavilion portion to said girdle portion, is 43.2% of said total girdle diameter of said girdle portion;
wherein said girdle portion has an upper peripheral edge formed at one side edge of said crown portion and a lower peripheral edge formed at one side edge of said pavilion portion so as to form a substantially circular shaped girdle portion, wherein said upper peripheral edge of said girdle portion is parallel to said lower peripheral edge thereof;
wherein said tip cut arrangement has a length not larger than ⅓ of a length of said pavilion portion and comprises sixteen quadrangle shaped fourth facets merging into said bottom peak point of said pavilion portion for enhancing light being concentratively reflected at said fourth facets back to said crown portion so as to maximize the brilliancy of said diamond;
wherein each of said fourth facets has two fourth lower side edges extended to form said bottom peak point of said pavilion portion and two fourth upper side edges extended from said fourth lower side edges to form a quadrangle shape, wherein a length of said fourth upper side edge of each of said fourth facets is shorter than a length of said fourth lower side edge thereof, such that said fourth facets are adapted for effectively enhancing the dispersion and brilliancy diamond by reflecting and refracting the light back from said crown portion;
wherein said body cut arrangement comprises sixteen quadrangle shaped fifth facets extended from said tip cut arrangement, wherein each of said fifth facets has two lower fifth side edges sharing with said fourth upper side edges of two of said neighboring fourth facets, and two upper fifth side edges extended from said lower fifth side edges respectively to form a quadrangle shape, wherein a length of said fifth lower side edge of each of said fifth facets is shorter than a length of said fifth upper side edge thereof;
wherein said top cut arrangement comprises sixteen sub-triangle shaped sixth facets, wherein each of said sixth facets has two sixth lower side edges sharing with said fifth lower side edges of two of said neighboring fifth facets, wherein said sixth lower side edges of each of said sixth facets are equal in length, wherein a length ratio between said sixth upper side edge and said fifth lower side edge is around 2.5, and a length ratio between said fourth lower side edge and said fifth lower side edge is around 1.5;
wherein a tip angle of said pavilion portion at said bottom peak point with respect to said tip cut arrangement is larger than a projected tip angle of said pavilion portion at said bottom peak point with respect to said body cut arrangement, so as to form said obtuse bottom peak point of said diamond;
wherein when the light is perpendicularly projected to said table facet of said crown portion at the critical point between said sixth facet and said fifth facet, the light is refracted back to said crown portion by another said sixth facet, therefore, the length of each of said sixth facets must be long enough for maximizing the light being concentratively refracted back to said crown portion so as to enhance the brilliancy of said diamond, wherein when the light is perpendicularly projected to said table facet of said crown portion at the critical point between said fifth facet and said fourth facet, the light is concentratively refracted back to said crown portion by another said fifth facet, therefore, the length of each of said fifth facets must be long enough for maximizing the light being refracted back to said crown portion so as to enhance the brilliancy of said diamond, wherein when the light is perpendicularly projected to said table facet of the crown portion close to said bottom peak point, the light is refracted back to said table facet of said crown portion.
